(19) United States
(12) Patent Application Publication
(10) Pub. No.: US 2016/0255818 A1
(43) Pub. Date: Sep. 8, 2016

(54) Pet Leash Assembly

(71) Applicant: Abraham Brooks, Newport News, VA (US)

(72) Inventor: Abraham Brooks, Newport News, VA (US)

(21) Appl. No.: 14/640,101

(22) Filed: Mar. 6, 2015

(51) Int. Cl. A01K 29/00; A01K 27/00

(52) U.S. Cl. CPC A01K 29/00; A01K 27/005

(57) ABSTRACT

A pet leash assembly includes a handle that has a pair of lateral members each coupled to and extending between a pair of longitudinal members. Each of the lateral members is spaced apart from each other such that the handle has a rectangular shape. A yoke is rotatably coupled to the handle and the yoke may have a plurality of leashes releasably attached thereto. The yoke rotates about an axis extending through the pair of longitudinal members such that the yoke allows the leashes to be untangled without the need to remove the leases from the yoke.

### BACKGROUND OF THE DISCLOSURE

### Field of the Disclosure

The disclosure relates to leash devices and more particularly pertains to a new leash device for allowing a plurality of leashes to be utilized while walking dogs in a manner that inhibits the leashes from becoming tangled.

### SUMMARY OF THE DISCLOSURE

An embodiment of the disclosure meets the needs presented above by generally comprising a handle that has a pair of lateral members each coupled to and extending between a pair of longitudinal members. Each of the lateral members is spaced apart from each other such that the handle has a rectangular shape. A yoke is rotatably coupled to the handle and the yoke may have a plurality of leashes releasably attached thereto. The yoke rotates about an axis extending through the pair of longitudinal members such that the yoke allows the leashes to be untangled without the need to remove the leases from the yoke.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a pet leash assembly according to an embodiment of the disclosure.

FIG. 2 is a right side view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

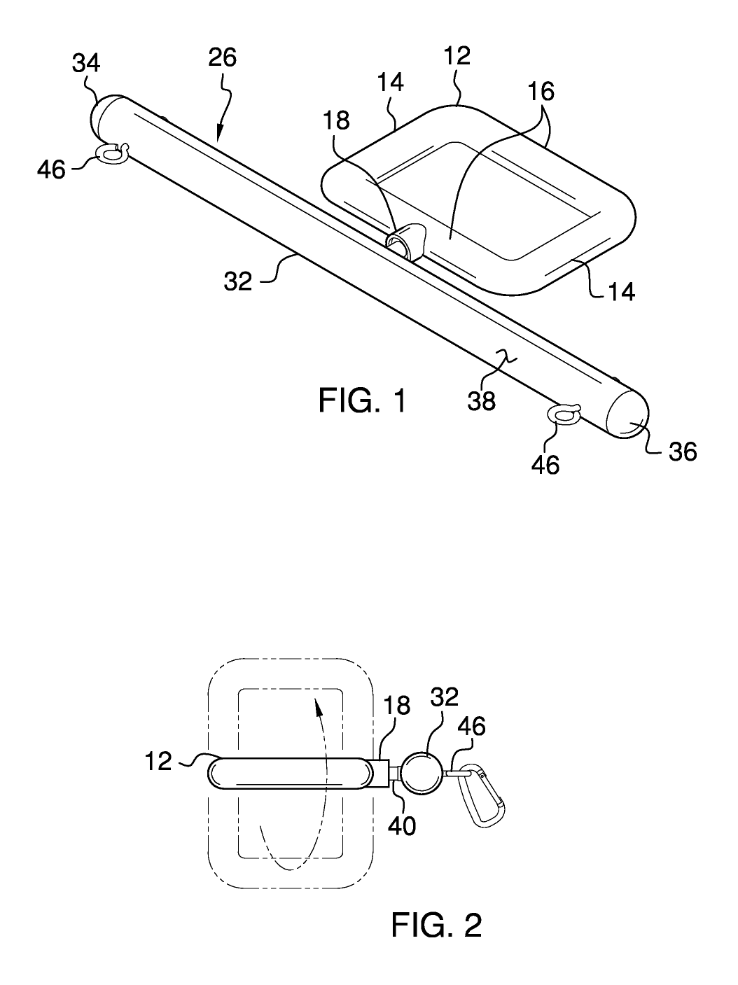

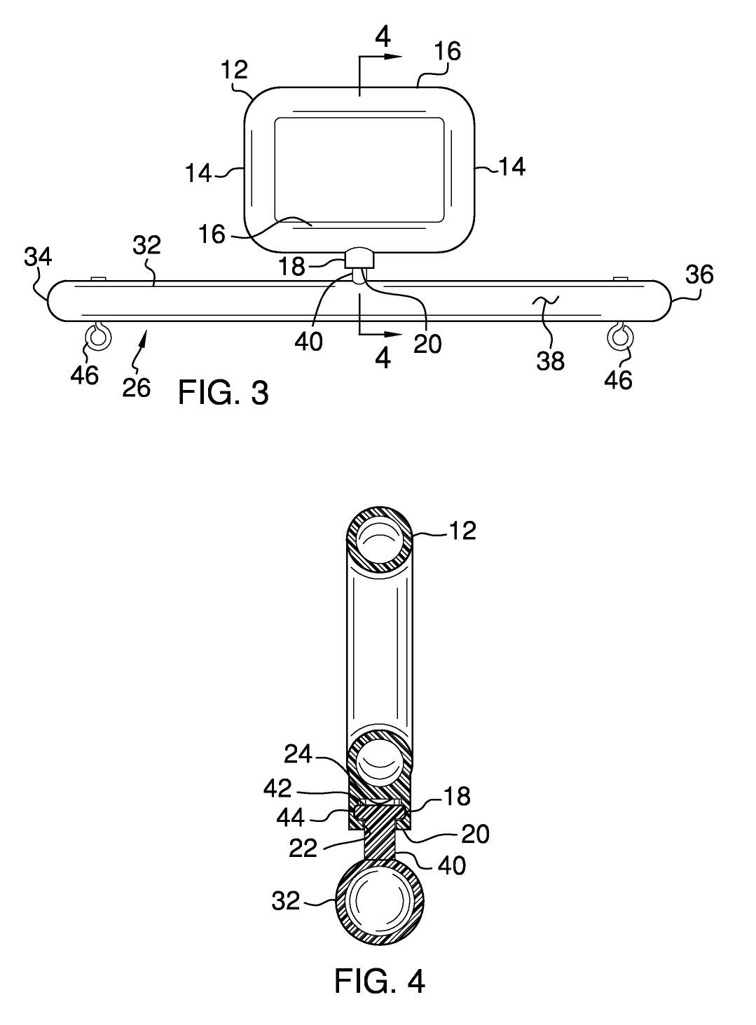

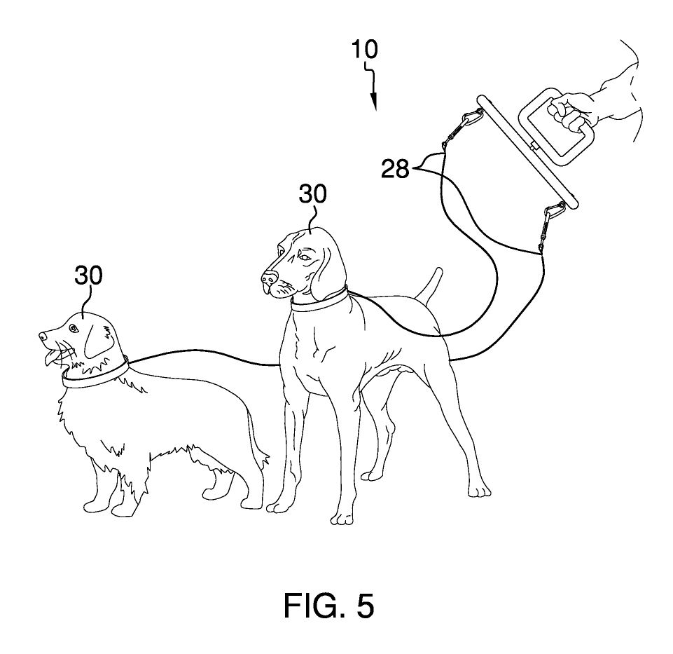

With reference now to the drawings, and in particular to FIGS. 1 through 5 thereof, a new leash device embodying the principles and concepts of an embodiment of the disclosure and generally designated by the reference numeral 10 will be described.

As best illustrated in FIGS. 1 through 5, the pet leash assembly 10 generally comprises a handle 12 that has a pair of lateral members 14 each coupled to and extending between a pair of longitudinal members 16. Each of the lateral members 14 is spaced apart from each other such that the handle 12 has a rectangular shape. The handle 12 has a receiving portion 18 extending away from one of the longitudinal members 16. The receiver portion 18 has a distal end 20 with respect to the longitudinal member 16 and the distal end 20 is open. The receiver portion 18 is substantially hollow and the receiver portion 18 has an inner surface 22. The inner surface 22 has groove 24 extending outwardly therein and the groove 24 extends around an entire circumference of the inner surface 22.

A yoke 26 is provided that is rotatably coupled to the handle 12 and the yoke 26 may have a plurality of leashes 28 releasably attached thereto. The leashes 28 may be dog leashes or the like and each of the leashes 28 may be attached to a dog 30. The yoke 26 rotates about an axis extending through the pair of longitudinal members 16 such that the yoke 26 allows the leashes 28 to be untangled without the need to remove the leashes 28 from the yoke 26.

The yoke 26 comprises a rod 32 that has a first end 34, a second end 36 and an outer surface 38 extending between the first end 34 and the second end 36. The rod 32 is elongated between the first end 34 and the second end 36. A coupler 40 is coupled to and extends away from the outer surface 38 and the coupler 40 is centrally positioned between the first end 34 and the second end 36. The coupler 40 has a distal end 42 with respect to the rod 32 and the distal end 42 of the coupler 40 flares outwardly from the coupler 40 to define an engaging edge 44 of the coupler 40. The engaging edge 44 is positioned within the groove 24 in the receiver portion 18 such that the coupler 40 is rotatably retained within the receiver portion 18.

A pair of hooks 46 is provided and each of the hooks 46 is coupled to the outer surface 38 of the rod 32. One of the hooks 46 is positioned adjacent to the first end 34 and one of the hooks 46 is positioned adjacent to the second end 36. Each of the hooks 46 may have one of the leashes 28 releasably attached thereto. The orientation of the hooks 46 on the rod 32 allows the dogs 30 to walk in opposite directions with respect to the rod 32 without tangling the leashes 28. The rod 32 is rotated with respect to the handle 12 if the leashes 28 become twisted around each other thereby facilitating the leashes 28 to be un-twisted without the need to remove the leashes 28 from the rod 32.

In use, the leashes 28 are attached to the hooks 46 to allow the dogs 30 to be walked. The spacing of the hooks 46 on the rod 32 allows the dogs 30 the freedom to move in opposite directions with respect to the rod 32. Additionally, if the leashes 28 become twisted around each other, the rod 32 is rotated to untwist the leashes 28. The leashes 28 remain attached to the hooks 46 while the rod 32 is rotated thereby allowing the dogs 30 to remain under control while the leashes 28 are untwisted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet leash assembly configured to allow multiple pets to be walked while allowing multiple leashes to be easily untangled, said assembly comprising:
a handle configured to be gripped, said handle having a pair of lateral members each coupled to and extending between a pair of longitudinal members, each of said lateral members being spaced apart from each other such that said handle has a rectangular shape; and
a yoke rotatably coupled to said handle, said yoke being configured to have a plurality of leashes releasably attached thereto, said yoke rotating about an axis extending through said pair of longitudinal members such that said yoke is configured to allow the leashes to be untangled without the need to remove the leases from said yoke.

2. The assembly according to claim 1, wherein said handle has a receiving portion extending away from one of said longitudinal members, said receiver portion having a distal end with respect to said longitudinal member, said distal end being open, said receiver portion being substantially hollow, said receiver portion having an inner surface, said inner surface having groove extending outwardly therein, said groove extending around an entire circumference of said inner surface.

3. The assembly according to claim 1, wherein said yoke comprises a rod having a first end, a second end and an outer surface extending between said first end and said second end, said rod being elongated between said first end and said second end.

4. The assembly according to claim 3, further comprising:
a receiver portion having a groove; and
a coupler coupled to and extending away from said outer surface, said coupler being centrally positioned between said first end and said second end, said coupler having a distal end with respect to said rod, said distal end flaring outwardly from said coupler to define an engaging edge of said coupler, said engaging edge being positioned within said groove in said receiver portion such that said coupler is rotatably retained within said receiver portion.

5. The assembly according to claim 4, further comprising a pair of hooks, each of said hooks being coupled to said outer surface of said rod, one of said hooks being positioned adjacent to said first end, one of said hooks being positioned adjacent to said second end, each of said hooks being configured to have one of the leashes releasably attached thereto.

6. A pet leash assembly configured to allow multiple pets to be walked while allowing multiple leashes to be easily untangled, said assembly comprising:
a handle configured to be gripped, said handle having a pair of lateral members each coupled to and extending between a pair of longitudinal members, each of said lateral members being spaced apart from each other such that said handle has a rectangular shape, said handle having a receiving portion extending away from one of said longitudinal members, said receiver portion having a distal end with respect to said longitudinal member, said distal end being open, said receiver portion being substantially hollow, said receiver portion having an inner surface, said inner surface having groove extending outwardly therein, said groove extending around an entire circumference of said inner surface; and
a yoke rotatably coupled to said handle, said yoke being configured to have a plurality of leashes releasably attached thereto, said yoke rotating about an axis extending through said pair of longitudinal members such that said yoke is configured to allow the leashes to be untangled without the need to remove the leases from said yoke, said yoke comprising:
a rod having a first end, a second end and an outer surface extending between said first end and said second end, said rod being elongated between said first end and said second end;
a coupler coupled to and extending away from said outer surface, said coupler being centrally positioned between said first end and said second end, said coupler having a distal end with respect to said rod, said distal end flaring outwardly from said coupler to define an engaging edge of said coupler, said engaging edge being positioned within said groove in said receiver portion such that said coupler is rotatably retained within said receiver portion; and
a pair of hooks, each of said hooks being coupled to said outer surface of said rod, one of said hooks being positioned adjacent to said first end, one of said hooks being positioned adjacent to said second end, each of said hooks being configured to have one of the leashes releasably attached thereto.
